(19) United States
(12) Patent Application Publication
(10) Pub. No.: US 2010/0278231 A1
(43) Pub. Date: Nov. 4, 2010

(54) Post-decoder filtering

(75) Inventors: Ron Gutman, San Diego, CA (US); David Drezner, Ra'anana (IL); Mark Petersen, San Diego, CA (US)

Correspondence Address: ROBERT G. LEV, 4766 MICHIGAN BLVD., YOUNGSTOWN, OH, 44505, US

(73) Assignee: Imagine Communications Ltd., Netanya (IL)

(21) Appl. No.: 12/799,954

(22) Filed: May 4, 2010

Related U.S. Application Data
(60) Provisional application No. 61/175,304, filed on May 4, 2009.

(51) Int. Cl. H04N 7/12; G06K 9/36

(52) U.S. Cl. 375/240.02; 382/251

(57) ABSTRACT

A method of providing post-processing information to client decoders. The method includes encoding a video, by an encoder and determining one or more parameters of sharpening, color space bias correction or contrast correction for post-processing of a frame of the encoded video. The method further includes transmitting the encoded video with the determined one or more parameters to a decoder.

### PRIORITY INFORMATION

The present invention claims priority to U.S. Provisional Application No. 61/175,304 which was filed on May 4, 2009, making reference to same herein, in its entirety.

### FIELD OF THE INVENTION

The present invention relates to communication systems and in particular to systems for delivery of video signals.

### BACKGROUND OF THE INVENTION

Delivering video content requires large amounts of bandwidth. Even when optical cables are provided with capacity for many tens of uncompressed channels, it is desirable to deliver even larger numbers of channels using data compression. Therefore, video compression methods, such as MPEG 2, H.264, Windows Media 9 and SMTPE VC-9, are used to compress the video signals. With the advent of video on demand (VoD), the bandwidth needs are even greater.

While various video compression methods achieve substantial reductions in the size of a file representing a video, the compression may add various artifacts. Therefore, it has been suggested that the receiver apply various post-processing acts to the decoded image, to improve its quality and make it more appeasable to the human eye. The applied post processing may include deblocking, deranging, sharpening, color bias correction and contrast correction. The H.264/AVC compression standard includes provisions for applying an adaptive deblocking filter that is designed to remove artifacts by the decoder.

GB patent publication 2,365,647, the disclosure of which is incorporated herein by reference in its entirety, suggests that after a video stream is encoded, before being transmitted, the video stream is decoded and the decoded video signal is analyzed to determine what post-processing will be required by the decoder of the receiver. The details of the required post-processing are forwarded to the receiver with the video stream. The post-processing is suggested to include filtering of borders between compression blocks of the images and wavelet noise reduction.

US patent publication 2005/0053288 to Srinivasan et al., titled: “Bitstream-Controlled Post-Processing Filtering”, the disclosure of which is incorporated herein by reference in its entirety, describes appending to transmitted video streams, control information on de-blocking and de-ringing filtering for post-processing by the receiver.

US patent publication 2009/0034622 to Huchet et al., titled: “Learning Filters for Enhancing the Quality of Block Coded Still and Video Images”, the disclosure of which is incorporated herein by reference in its entirety, describes a learning filter generator at the encoder which provides filter parameters for block boundaries to the decoder.

While performing the deblocking and deringing at the receiver under instructions from the encoder may achieve better deblocking and deringing results, the deblocking and deringing do not succeed to eliminate the blocking and ringing completely and an improvement in quality of decoded videos is required.

### SUMMARY OF THE INVENTION

An aspect of some embodiments of the present invention relates to appending post-processing instructions on sharpening, color space bias correction and/or contrast correction to transmitted video. The inventors of the present invention have determined that there are substantial advantages in adjusting the sharpening, color space bias correction and/or contrast correction to the specific encoding performed and hence the transmission of instructions in this regard from the encoder is worth the extra effort in transmitting the instructions.

In some embodiments of the invention, the appended post-processing instructions include instructions on both sharpening and de-blocking filters to achieve a desired coordination between the sharpening and the de-blocking. Possibly, the appended post-processing instructions include instructions on sharpening, de-blocking and de-ringing.

In some embodiments of the present invention the appended post-processing instructions are selected responsive to a comparison of an original version of the video before it was encoded to the results of applying a plurality of different filters to the decoded video. Comparing the filter results to the original version of the video ensures that the post-processed video is a more accurate copy of the original video than if the selection of the post-processing filters is performed without relation to the original. This is especially useful when the original purposely includes details or other effects which may be mistakenly removed.

The filters selected for a specific frame may be used only for that frame or may be used for a sequence of frames, such as a GOP of frames or an entire scene. The selected filters are generally used for a portion of the frame or sequence of frames for which they were selected, but in some cases may be used for the entire frame or sequence of frames.

In some embodiments of the invention, the selection of the post-processing filters to be used is performed by the encoder or at the encoder site, using a complete copy of the original video. The encoder determines which filters are to be used in the post-processing and appends indications of its selections to the encoded video version, for transmission to receivers. Alternatively, a complete copy of the original video is provided along with the encoded version of the video to a processing unit remote from the encoder. The remote processing unit appends indications of its selections to the encoded video version, for transmission to receivers. In some embodiments of the invention, the selection of the post-processing filters is performed a substantial time after the encoding of the video, for example more than a day, more than a week, more than a month or even more than a year after the encoding. Possibly, the selection of the post-processing filters is performed in stages, for example based on available bandwidth, available processing power and/or importance ratings of videos. In a first stage, filters of a first type (e.g., sharpening) may be selected, while at a later time a second stage involves selecting filters of a different type (e.g., de-ringing filters). Between the first and second stages, the encoded video is provided with indications of those filters already selected. For example, the first stage may perform a limited filter selection in real time for users viewing the video in real-time, while a more thorough selection is performed at a later time for users viewing the video later on.

Instead of using a complete copy of the original video in the selection of post-processing filters, the selection may be performed based on a limited set of frames from the original video stream. For example, the remote processing unit performing the post-processing filter selection may receive along with the encoded video, the I-frames of the original stream and perform the filter selection for each group of pictures (GOP) based on its I-frame(s). Possibly, the remote processing unit is provided a subset of the I-frames of the original video, for example a single I-frame for each scene, and performs the filter selection for each scene based on its I-frame. In some cases, such as when the bandwidth required for the scene frames is not large, this may allow the filter selection to be performed closer to the receiver or even at the receiver. In some embodiments of the invention in which the filter selection is performed in stages, different sets of content from the original video (e.g., the entire video, all the I-frames, a subset of the I-frames) are used in different stages and/or the different stages are performed in different locations.

In some embodiments of the present invention the selected post-processing instructions are based on an objective quality measure of the results of a plurality of filters or filter sequences as applied to the frames of the video. In some embodiments of the invention, the objective quality measure is based on a weighted sum of grades for a plurality of different quality parameters, such as blockiness, blurinesss, noise, haloing and color bias. Optionally, the objective quality measure depends on at least four different quality measures. Optionally, the objective video quality measure uses Human Visual System (HVS) Model weighting the artifacts according to parameters such as texture and motion.

Optionally, for each filter or filter sequence selected, at least 5, at least 50 or even at least 500 filters or sequences of filters are tested. In some embodiments of the invention, the filter testing is performed in a plurality of levels. For example, in a first phase a variety of different filters are tested to find a limited number of promising filters and in a second phase filters similar to the promising filters are tested to find a best filter. Naturally, also three or more phases may be used.

An aspect of some embodiments of the present invention relates to an encoder which identifies image areas which will suffer from high blockiness and/or ringing due to a high quantization parameter (QP) required to achieve bandwidth limits and blurs the identified image areas to reduce the QP they require. The inventors of the present invention have found that under some circumstances it is preferable to blur an image, rather than cause blockiness and ringing, especially since the post processing sharpening for correction of blurring may be more effective than deranging and deblocking.

In some embodiments of the invention, the encoder indicates in the videos it generates that it performs blurring, in accordance with an embodiment of the present invention in order to allow the decoder to take this into account in performing its post-processing. The indication may be provided once for each video, in every I-frame or even in every frame. The indication may be provided in an “encoder type” field or may be provided in any other field. It is noted that the number of bits used for the indication may be very small and even may include only a single bit. In other embodiments, the encoder does not indicate that it performs blurring on areas having a high QP, as the decoder does not necessarily need to adjust itself to the blurring. In some embodiments of the invention, decoders may determine encoders that perform blurring on identified high QP areas based on an analysis of the encoding of one or more frames of a video, for example by determining the extent of deviation between the QP of different areas of a frame. Optionally, frames having a low QP deviation are considered as resulting from an encoder which performs blurring on areas identifies as having a high QP, as the low deviation is indicative of a truncation of high QP values.

In some embodiments of the invention, the decoder is designed to perform sharpening post-processing to overcome the blurring performed by the encoder. The sharpening post-processing may be performed based on instructions from the encoder or independently. In some embodiments of the invention, the encoder is configured with the post-processing rules of the decoder and accordingly selects the extent of blurring to be performed. Optionally, the encoder tries a plurality of possible blurring extents applies the decoding expected to be performed by the decoder to the results and compares the results after post-processing to the original encoded frame and accordingly selects the extent of blurring to be used.

Optionally, the encoder differentiates between different types of image features and applies different blurring extents to different image areas in the same frame. For example, for areas identified as part of a face a low extent of blurring is used, if at all, while for areas identified as high texture (e.g., a tree or a crowd), a higher extent of blurring is used.

An aspect of some embodiments of the present invention relates to an encoder which is configured to vary the extent it compresses different areas of a single frame, according to the type of image features in the different areas. Optionally, areas of face features are compressed less, while areas of texture are compressed by a larger extent.

The extent of compression is optionally achieved by setting the quantization parameter (QP) and/or by blurring. In some embodiments of the invention, blurring is used when a QP above a predetermined value is required to achieve a compression goal, so as to lower the required QP. The extent of blurring may be increased linearly with the required QP without blurring. Alternatively, the extent of blurring may depend on the required QP-without-blurring in a non-linear manner, for example increasing the extent of blurring to a high extent close to a threshold QP value at which blurring is applied and then increasing the blurring extent to a lower extent for higher QP values.

An aspect of some embodiments of the present invention relates to a decoder adapted to randomly add temporal noise to image areas determined to be blurred. Optionally, the temporal noise is added in at least some frames only to a portion of the frame, such that there remain some areas of the frame to which noise is not added. Optionally, adding the temporal noise includes changing the luminance of randomly selected pixels in the area to which noise is added.

In some embodiments of the invention, the temporal noise is added to blocks of the frame that have a high QP which is indicative that the encoder blurred the area of the image included in the block. Optionally, the encoder only uses a QP values above a specific threshold for frame blocks that were blurred and the decoder adds noise only to blocks with a QP above the threshold. Alternatively or additionally, the encoder appends to the video for each frame, indication of the blocks that were blurred. Further alternatively or additionally, the decoder analyzes the frame using image analysis methods to identify blurry areas and/or areas indicative of high texture.

An aspect of some embodiments of the present invention relates to a decoder adapted to adjust the post processing it performs to frame blocks responsive to the compression extent of the block, for example as indicated by the QP value of the encoding and/or the bit rate.

In an exemplary embodiment of the invention, when the QP is high the decoder performs detail enhancement, adds temporal noise and/or performs other sharpening post processing, while for low QP the decoder performs little detail enhancement or none at all. Optionally, a block is considered as having a high QP when its QP is higher than an average QP value of its frame and is also higher than an average QP value of recent frames of the same type (e.g., I-frames, B-frames, P-frames) in the video, so that random variations in the QP of the frame are not interpreted as meaningful high QP values.

An aspect of some embodiments of the invention relates to a decoder which applies post processing to a decoded video with attributes selected responsive to one or more attributes of the screen on which the video is displayed. Optionally, the post-processing depends on the size and/or type of the screen on which the decoded video from the decoder is displayed. In some embodiments of the invention, for smaller screens, more edge enhancement is performed than for large screens. Optionally, the extent of edge enhancement is larger for LCD screens than for plasma screens. Alternatively or additionally, for screens of low contrast, more contrast correction is performed.

There is therefore provided in accordance with an exemplary embodiment of the invention, a method of providing post-processing information to client decoders, comprising encoding a video, by an encoder, determining one or more parameters of sharpening, color space bias correction or contrast correction for post-processing of a frame of the encoded video; and transmitting the encoded video with the determined one or more parameters to a decoder.

Optionally, the encoding of the video and determining the one or more parameters are performed by a single processor. Alternatively, the encoding of the video and determining the one or more parameters are performed by different units. Optionally, the different units are separated by at least 100 meters. Optionally, the method includes transmitting the encoded video from the encoder to a unit determining the one or more parameters over an addressable network.

Optionally, transmitting the encoded video to the unit determining the one or more parameters comprises transmitting along with a version of the frame including more information than available from the encoded video. Optionally, determining the one or more parameters comprises decoding the frame, applying a plurality of post-processing filters to the decoded frame; and selecting one or more of the applied filters, based on a comparison of the results of applying the filters to the decoded frame to a version of the frame including more information than available from the encoded frame.

Optionally, selecting the one or more filters is performed at least a day after the generation of the encoded video. Optionally, the method includes selecting additional filters for the frame after transmitting the encoded video with the parameters from the first selection to client decoders.

Optionally, the version of the frame including more information than available from the encoded frame comprises an original frame from which the encoded frame was generated. Optionally, the version of the frame including more information than available from the encoded frame comprises a frame decoded from a higher quality encoding of the encoded frame. Optionally, the determining of parameters is repeated for a plurality of frames of the encoded video. Optionally, the determining of parameters is repeated for at least 95% of the frames of the encoded video.

Optionally, the determining of parameters is repeated for at most one frame in each group of pictures (GOP). Alternatively or additionally, the determining of parameters is repeated for substantially only the I-frames of the encoded video. Optionally, selecting one or more of the applied filters comprises assigning to each filtered version of the frame an objective quality measure and selecting the one or more filters that achieve the filtered version with the best objective quality measure. Optionally, the objective quality measure depends on at least four different quality measures. Optionally, the objective quality measure depends on at least blockiness, blurriness, noise, haloing and color bias. Optionally, applying a plurality of post-processing filters comprises applying at least 50 filters for each selected filter.

Optionally, applying a plurality of post-processing filters comprises applying a plurality of sequences of filters from which a single sequence of filters is selected.

Optionally, determining the one or more parameters comprises determining one or more parameters of a post-processing sharpening filter. Optionally, determining the one or more parameters comprises determining blocks of the frame that are to be post-processed. Optionally, determining blocks of the frame that are to be post-processed comprises determining blocks that were blurred during the encoding. Optionally, determining the one or more parameters comprises determining one or more parameters of color bias correction filter. Optionally, transmitting the video with the one or more parameters comprises transmitting in a manner such that the one or more parameters are ignored by decoders not designed to use the parameters. Optionally, determining the one or more parameters comprises determining responsive to decisions made during the encoding.

There is further provided in accordance with an exemplary embodiment of the invention, an encoder, comprising an input interface which receives a video formed of frames, an image analyzer adapted to determine for an analyzed frame, areas of the frame that are expected to be substantially degraded by encoding, a low pass filter adapted to blur areas identified by the image analyzer and an encoder adapted to encode frames after areas were blurred by the low pass filter.

Optionally, the image analyzer is adapted to determine areas that are expected to be substantially degraded by encoding, by encoding the frame. Optionally, the image analyzer is adapted to determine areas that are expected to be substantially degraded by encoding, by determining a quantization parameter for blocks of the frame. Optionally, the low pass filter is adapted to adjust the extent to which it blurs areas to a quantization parameter of the area.

Optionally, the image analyzer is adapted to determine areas that have important details and therefore will be assigned more bits for encoding and will not be degraded by encoding. Optionally, the encoder is adapted to mark encoded frames with an indication that the encoder is adapted to perform blurring before encoding. Optionally, the encoder is adapted to indicate in the encoded frame areas of the frame that were blurred. Optionally, the encoder is adapted to encode the frame in a manner such that areas that were blurred have a quantization parameter different from areas that were not blurred.

There is further provided in accordance with an exemplary embodiment of the invention, a method of encoding, comprising receiving a video frame by a processor, determining by the processor areas of the frame that are expected to be substantially degraded by encoding, blurring the determined areas and encoding the frame after the determined areas were blurred.

Optionally, determining the areas expected to be degraded comprises encoding the frame and determining areas requiring larger numbers of bits for their encoding and/or analyzing the image to determine areas of the frame which show image details sensitive to detail loss. Optionally, encoding the frame comprises encoding such that blurred areas have a higher quantization parameter than other areas of the frame.

There is further provided in accordance with an exemplary embodiment of the invention, a method of decoding a video frame, comprising receiving an encoded video frame, by a decoder, decoding the received frame, by the decoder, identifying areas of the frame that are considered to have been degraded by the encoding and sharpening the identified areas.

Optionally, sharpening the identified areas comprises sharpening different areas of the frame by different sharpening extents. Optionally, identifying areas of the frame that are considered to have been degraded by the encoding comprises for some frames identifying the entire frame as requiring sharpening. Optionally, sharpening the identified areas comprises sharpening by an extent selected responsive to an estimated degradation by the encoder. Optionally, identifying areas of the frame comprises identifying based on the quantization parameters of the areas of the frame.

Optionally, identifying areas of the frame comprises identifying areas having a quantization parameter higher than other areas of the frame and higher than an average quantization parameter of previous frames of the same type in a video to which the frame belongs. Optionally, identifying areas of the frame comprises identifying by image analysis. Optionally, identifying areas of the frame comprises receiving indications of the areas in meta data supplied with the frame. Optionally, sharpening the identified areas comprises adding temporal noise to the identified areas. Optionally, adding the temporal noise comprises adding to pixels selected randomly. Optionally, sharpening the identified areas comprises applying detail enhancement to the identified areas. Optionally, sharpening the identified areas comprises detail enhancement or edge enhancement functions

There is further provided in accordance with an exemplary embodiment of the invention, a method of decoding a video frame, comprising receiving an encoded video frame, by a decoder, decoding the received frame, by the decoder, selecting areas of the frame that are to be sharpened and areas not to be sharpened and adding temporal noise to the areas selected to be sharpened but not to the areas not to be sharpened.

Optionally, selecting areas of the frame comprises selecting based on the quantization parameters of the areas of the frame. Optionally, selecting areas of the frame comprises identifying areas having a quantization parameter higher than other areas of the frame and higher than an average quantization parameter of previous frames of the same type in a video to which the frame belongs.

Optionally, selecting areas of the frame comprises selecting by image analysis.

Optionally, selecting areas of the frame comprises receiving indications of the areas in meta data supplied with the frame. Optionally, adding the temporal noise comprises adding to pixels selected randomly.

There is further provided in accordance with an exemplary embodiment of the invention, a method of decoding a video frame, comprising receiving an encoded video frame, by a decoder, decoding the received frame, determining one or more encoding parameters of the received frame; and post processing the decoded frame using one or more attributes selected responsive to the determined one or more encoding parameters.

Optionally, post processing the decoded frame comprises sharpening areas having a high quantization parameter, possibly higher than other areas of the frame and higher than an average quantization parameter of previous frames of the same type in a video to which the frame belongs.

Optionally, determining one or more encoding parameters comprises determining one or more quantization parameters of blocks of the frame. Optionally, determining one or more encoding parameters comprises determining one or more motion vectors of the frame.

Optionally, post processing the decoded frame comprises post processing all the blocks of the frame using a same post processing method. Optionally, post processing the decoded frame comprises post processing a portion of the frame using a first filter while some portions of the frame are not post processed using the first filter.

There is further provided in accordance with an exemplary embodiment of the invention, a method of decoding a video frame, comprising receiving an encoded video frame, by a decoder, decoding the received frame, determining one or more parameters of a screen on which the decoded frame is to be displayed and/or of the decoder and post processing the decoded frame responsive to the one or more determined parameters.

Optionally, the one or more parameters comprise the size of the screen, the type of the screen, the contrast ratio of the screen and/or the CPU power available for post processing functions by the decoder.

There is therefore provided in accordance with an exemplary embodiment of the invention, a method of providing post-processing filter information to client decoders, comprising receiving an encoded video, decoding a frame of the encoded video, applying a plurality of post-processing filters to the decoded frame, by one or more processors, selecting one or more of the applied filters, based on a comparison of the results of applying the filters to the decoded frame to a version of the frame including more information than available from the encoded frame, appending information on the selected one or more filters to the encoded video; and transmitting the encoded video with the appended information to client decoders.

Optionally, the encoded video is generated by the one or more processors applying the post-processing filters. Optionally, the encoded video is generated by an encoder remote from the one or more processors applying the post-processing filters. Optionally, receiving the encoded video comprises receiving over an addressable network. Optionally, receiving the encoded video comprises receiving along with the version of the frame including more information than available from the encoded frame. Optionally, selecting the one or more filters is performed at least a day after the generation of the encoded video.

Optionally, the method includes selecting additional filters for the frame after transmitting the encoded filter with the appended information from the first selection to client decoders. Optionally, the decoding, applying of post-processing filters and selecting of applied filters are repeated for a plurality of frames of the encoded video, possibly for at least 95% of the frames of the encoded video or even for substantially all of the frames of the encoded video. Optionally, the decoding, applying of post-processing filters and selecting of applied filters are repeated for at most one frame in each group of pictures (GOP). Optionally, the decoding, applying of post-processing filters and selecting of applied filters are repeated for substantially only the I-frames of the encoded video. Optionally, selecting one or more of the applied filters comprises assigning to each filtered version of the frame an objective quality measure and selecting the one or more filters that achieve the filtered version with the best objective quality measure. Optionally, the objective quality measure depends on at least four different quality measures. Optionally, the objective quality measure depends on at least blockiness, blurinesss, noise, haloing and color bias.

Optionally, applying a plurality of post-processing filters comprises applying at least 50 filters for each selected filter. Optionally, applying a plurality of post-processing filters comprises applying a plurality of sequences of filters from which a single sequence of filters is selected. Optionally, applying a plurality of post-processing filters comprises applying a plurality of sharpening filters. Optionally, applying a plurality of post-processing filters comprises applying both sharpening and de-blocking filters. Optionally, applying a plurality of post-processing filters comprises applying a plurality of color bias correction filters. Optionally, the version of the frame including more information than available from the encoded frame comprises an original frame from which the encoded frame was generated.

Optionally, the version of the frame including more information than available from the encoded frame comprises a frame decoded from a higher quality encoding of the encoded frame. Optionally, appending information on the selected filters to the encoded video comprises appending in a manner which is ignored by units not designed to use the appended information.

Optionally, the method includes additionally appending information on filters not to be applied to the frames. Optionally, applying a plurality of post-processing filters to the decoded frame comprises applying only to areas in which artifacts were identified. Optionally, applying a plurality of post-processing filters to the decoded frame comprises applying to areas of the frame selected without relation to whether artifacts were identified. Optionally, applying a plurality of post-processing filters to the decoded frame comprises applying only to areas of the frames identified to differ substantially from the version of the frame including more information than available from the encoded frame. Optionally, applying a plurality of post-processing filters to the decoded frame comprises applying at least some filters selected responsive to the preprocessing filters applied to the frame.

Optionally, appending information on the selected one or more filters to the encoded video comprises appending the information along with priority indications of the filters. Optionally, appending information on the selected one or more filters to the encoded video comprises appending the information along with indications of the extent of quality improvement provided by the filters.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic block diagram of an encoding system, in accordance with an exemplary embodiment of the invention;

FIG. 2 is a block diagram of a video provision system, in accordance with an exemplary embodiment of the invention;

FIG. 3 is a flowchart of acts performed by an encoder in encoding a frame, in accordance with an exemplary embodiment of the invention; and

FIG. 4 is a flowchart of acts performed by a decoder, in accordance with an exemplary embodiment of the invention.

### DETAILED DESCRIPTION OF EMBODIMENTS

### Overview

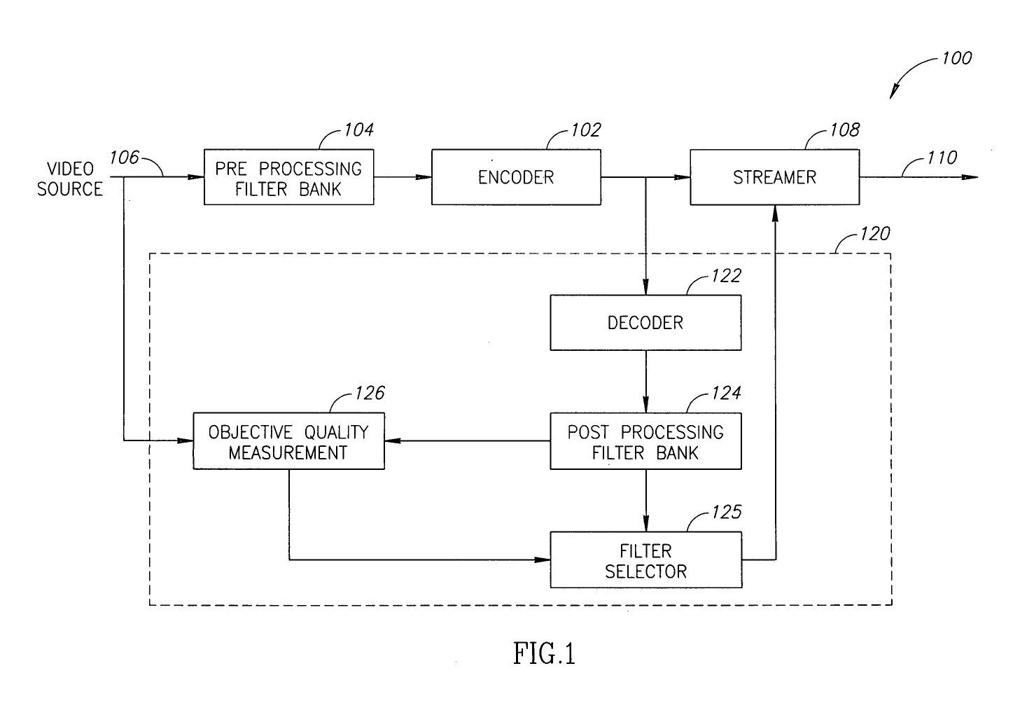

FIG. 1 is a schematic block diagram of an encoding system 100, in accordance with an exemplary embodiment of the invention. Encoding system 100 comprises an encoder 102, which receives videos for encoding from an input line 106. Optionally, the videos are passed through a pre-processing filter bank 104, before being provided to the encoder 102, as is known in the art. The encoded video stream is passed from encoder 102 to a streamer 108, which transmits encoded video streams to storage units and/or to clients, over a communication channel 110.

In accordance with embodiments of the invention, encoding system 100 further includes a filter selection unit 120, which prepares post-processing filtering instructions which are appended to encoded videos. Filter selection unit 120 comprises a decoder 122, which decodes the encoded video to achieve the decoded video which is displayed by the clients. A post-processing filter bank 124 applies various filters to the frames of the decoded video and a quality measurement unit 126 determines the quality of the frames after each of the various filters were applied thereto. A filter selector 125 determines which filter or sequence of filters achieves a best result, for each video unit, such as frame, group of frames and/or scene. Accordingly, filter selector 125 generates post-processing instructions which are appended to the encoded video and transmitted by streamer 108.

### Filter Bank

Filter bank 124 optionally includes a plurality of different types of post-processing filters, for example at least three or even at least four different types of filters. Optionally, the filter types include de-blocking, de-ringing, sharpening and/or color space bias correction filters. The de-ringing filters are optionally represented by their contour coordinates and direction.

Optionally, filter bank 124 applies a relatively large number of filters to each handled frame. In some embodiments of the invention, more than a thousand or even more than 10,000 filters are applied to the frame. Optionally, the encoder applies at least 100 or even at least 500 filters in order to select a single filter or filter sequence with a best result.

In some embodiments of the invention, the clients are configured to apply one or more post-processing filters without receiving instructions from encoding system 100. Optionally, in these embodiments, filter bank 124 determines which filters will be applied by the client decoder without instructions from filter selection unit 120, based on the decoding protocol used by the decoder, and only relates to other frame regions and/or filter types. Alternatively, filter selection unit 120 determines best filters of all types and frame regions, but does not select filters which will anyhow be applied by the decoder without instructions from filter selection unit 120. In some embodiments of the invention, the instructions from filter selection unit 120 include instructions on filters not to be applied from the filters which the decoder would apply on its own, and/or instructions on changes to the parameters of the filters that the decoder is to apply.

The range of filters in filter bank 124 may be selected using any method known in the art, such as any of the methods described in above mentioned patent publications GB patent publication 2,365,647, US patent publication 2005/0053288 and US patent publication 2009/0034622.

Optionally, filter selection unit 120 reviews each handled frame to identify artifacts of one or more types. For each identified artifact, a plurality of filters of one or more types, with different parameters are applied to the region of the artifact, and the filter providing a result closest to the original is selected. Instead of to artifacts, the filters may be applied to regions having predetermined characteristics, such as regions including text, edges and/or borders between blocks. Alternatively or additionally, one or more filters are applied throughout the frame regardless of whether an artifact was found and filters resulting in an image closer to the original than the decoded version are selected. Further alternatively or additionally, the decoded version of each handled frame is compared to the original frame and accordingly regions with large differences are identified. To these regions a plurality of filters having different parameters are applied and the filter providing closest results to the original are selected.

Sharpening filters are optionally applied to high texture frame regions. Alternatively, sharpening filters are not applied to areas determined to show a face.

In some embodiments of the invention, each filter is tested separately on the decoded video. Alternatively, filter bank 124 applies sequences of filters which may effect each other and the sequence that provides best results is chosen. For example, filter bank 124 may apply a plurality of sequences of de-blocking and sharpening filters, and select the best sequence, as sharpening and de-blocking filters interact with each other and their combined selection may achieve better results than separate selection.

In some embodiments of the invention, post-processing filter bank 124 includes a predetermined set of filters to be used on all frames. Alternatively, the tested filter banks are at least partially selected responsive to information on the frame from encoder 102 or from pre-processing filter bank 104. For example, post-processing filter bank 124 may test additionally, mainly or solely filters which reverse the effect of the pre-processing filters applied to the specific frame and/or of in-loop frames applied by encoder 102.

### Quality Level Measurement

The quality level of frames or portions thereof (e.g., macro-blocks) is optionally measured using any suitable method known in the art, such as based on peak signal noise ratio (PSNR) or any of the methods described in “Survey of Objective Video Quality Measurements”, by Yubing Wang, downloaded from ftp://ftp.cs.wpi.edu/pub/techreports/pdf/06-02.pdf, the disclosure of which is incorporated herein by reference.

In some embodiment of the invention, the quality level is measured using any of the methods described in U.S. Pat. No. 6,577,764 to Myler et al., issued Jun. 10, 2003, U.S. Pat. No. 6,829,005 to Ferguson, issued Dec. 7, 2004, and/or U.S. Pat. No. 6,943,827 to Kawada et al., issued Sep. 13, 2005, the disclosures of which are incorporated herein by reference. Alternatively or additionally, the quality level is measured using any of the methods described in “Image Quality Assessment: From Error Measurement to Structural Similarity”, Zhou Wang, IEEE transactions on Image Processing, vol. 13, no. 4, April 2004, pages 600-612 and/or “Video Quality Measurement Techniques”, Stephen Wolf and Margaret Pinson, NTIA Report 02-392, June 2002, the disclosures of both of which are incorporated herein by reference. It is noted that the quality level function may be in accordance with a single one of the above cited references or may combine, for example in a linear combination, features from a plurality of the above articles and patents.

### Operation

In some embodiments of the invention, filters are selected for each frame of the video. Alternatively, filter selection unit 120 operates only on some frames, such as only on I-frames, or only on a single frame in each scene. The selected filters for one frame may be used on other frames of the same GOP or scene.

Encoder 102 may operate in accordance with any compression method known in the art, for example a block-based compression method such as the MPEG-4 compression.

Encoding system 100 may operate on real-time or non-real time video streams and/or files. Accordingly, streamer 108 may supply the encoded video directly to clients or to a storage unit, for example of a video on demand (VoD) server.

The encoded post-processing instructions are optionally encoded to require less than 1% of the bandwidth of the encoded video stream, optionally less than 0.1%. In some embodiments of the invention, the maximal amount of data required to represent the filters of a single frame is less then 100 bits.

The encoded post-processing instructions are optionally appended to the encoded video in a manner such that clients not designed to identify the instructions will ignore the instructions as padding. In an exemplary embodiment, the post-processing instructions are appended to the video, possibly with metadata on the video, in a manner which converts the video from a variable bit rate (VBR) stream into a constant bit rate (CBR) stream, for example using any of the embodiments described in US patent publication 2009/0052552, to Gutman, titled: “Constant bit rate video stream”, the disclosure of which is incorporated herein by reference in its entirety.

### Distributed Operation

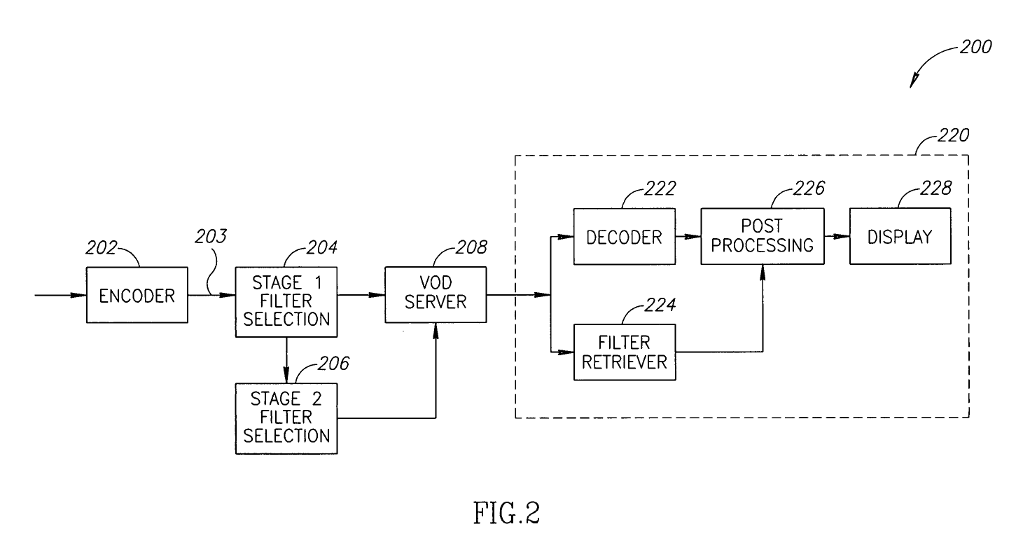

FIG. 2 is a block diagram of a video provision system 200, in accordance with an exemplary embodiment of the invention. Video provision system 200 includes an encoder 202 which encodes the video for transmission to a client 220. Rather than performing the post-processing filter selection in an internal unit of the encoder, as in encoding system 100, the post-processing filter selection is performed by one or more separate filter selection units. In FIG. 2, two filter selection units 204 and 206 are shown, although in some embodiments only a single selection unit is used, and in other embodiments three or more selection units are used.

As shown, video provision system 200 includes a first stage filter selection unit 204 which selects some post-processing filters. The encoded video is transferred along with indications of the selected filters to a VoD server 208, which immediately begins providing the video to clients 220. Optionally, in parallel, the encoded video is provided to a second stage filter selection unit 206 which performs additional tests for filter selection.

The communication channel 203 between encoder 202 and filter selection unit 204 may comprise a relatively long distance connection of at least 100 meters or even more than 10 kilometers. In some embodiments of the invention, communication channel 203 operates in accordance with a standard communication protocol, such as IP, Ethernet and/or another packet based protocol. In some embodiments of the invention, communication channel 203 comprises a local area network (LAN) or a wide area network (WAN). Optionally, one or more portions of communication channel 203 pass through an optical fiber or over a wireless link, for example a satellite or cellular communication link.

Client 220 comprises a decoder 222 and a filter retriever which extracts filter instructions from filter selection unit 204 and/or 206. The retrieved filter instructions are optionally provided to post-processing unit 226 and the resultant post-processed video is displayed on display 228.

In some embodiments of the invention, selection units 204 and/or 206 receive the encoded video along with some original frames to allow better filter selection. Optionally, the original frames are received for at least one other reason, for example for playback control. Alternatively or additionally, replacement blocks carrying the original video or higher quality video than the encoded video, as described in US patent publication 2006/0195881 to Segev et al., the disclosure of which is incorporated herein by reference, are used also for the selection of post-processing filters.

In other embodiments, selection unit 204 does not receive original frames of the video and the quality of measurement is performed without comparison to the original.

In some embodiments of the invention, first stage filter selection unit 204 selects filters of one or more first types (e.g., de-blocking), and second stage selection unit 206 selects filters of one or more other types (e.g., color bias correction). Alternatively or additionally, second stage selection unit 206 performs a more in-depth selection of the same type of filters, for example trying a larger number of filters. Second stage filter selection unit 206 may spend substantially more time on the filter selection, for example more than 10 times more.

It is noted that instead of VoD server 208, system 200 may include a different unit which distributes video to clients. Particularly, the video may be distributed in real-time, by a streaming unit, such as a teleconferencing hub or a broadcast unit.

In some embodiments of the invention, filter selection unit 204 serves as a central high processing power unit. For example, in a teleconferencing network, the encoder 202 and the client are preferred to be of limited processing power, and the post-processing filter selection is performed by filter selection unit 204.

### Encoder

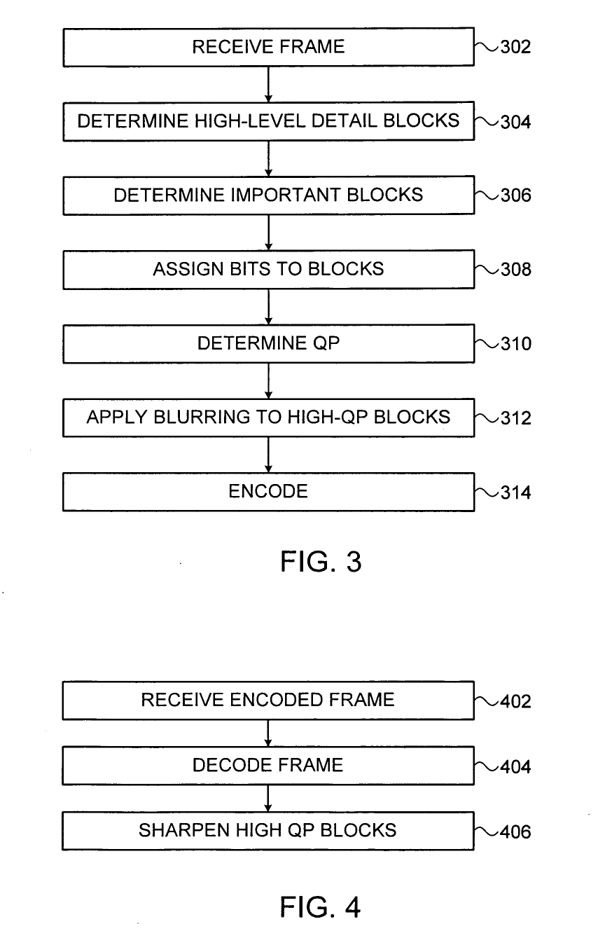

FIG. 3 is a flowchart of acts performed by an encoder in encoding a frame, in accordance with an exemplary embodiment of the invention. Upon receiving (302) a frame for encoding, the encoder analyzes the frame to determine (304) which of its blocks include a high level of details. For the high level detail blocks, the encoder optionally determines (306) whether the details of the block are important for example because they show a face or are less important because they belong to a texture. The encoder then assigns (308) bits to the different blocks, giving more bits to blocks that have high levels of detail considered important. The encoder then determines (310) for each block the quantization parameter (QP) it will be assigned in its encoding, according to the bits assigned to the block. For blocks having a high QP, a blurring filter, such as a low pass filter (LPF), is applied (312) to the block. The blocks are then encoded (314).

In some embodiments of the invention, the encoder appends to the encoded frame indication of the blocks to which blurring was applied. Alternatively, no such indication is appended, as in some embodiments the decoder can determine which blocks have been blurred from the QP of the block or from other parameters, as discussed hereinbelow.

As to determining (304) which blocks have a high level of detail, the determination optionally includes encoding the blocks and determining the resultant quantization parameter (QP). Blocks with a quantization parameter above a predetermined threshold, e.g., 40 or 45, are considered as having a high level of detail.

Referring in more detail to determining (306) whether the details of the block are important, in some embodiments of the invention the determination includes searching for faces, slow gradients or low spatial frequencies in backgrounds, such as sky or water, and other image types which are known to be important In some embodiments, frames belonging to a sequence of frames having a low amount of motion between frames are considered important in order to prevent compression artifacts that are generally more visible in relatively static scenes. Optionally, when an entire frame is considered important or when substantial parts of the frame are considered important, the frame may be assigned a number of bits greater than average, for example in a VBR encoding and/or in a multi-stream encoding of a statistical multiplexer. Alternatively or additionally, the determination of which blocks are important may be based on indications from a human who indicates frame areas that are important and/or provides images that are important and the encoder searches for similar images in the frames being encoded.

As to assigning (308) bits to the blocks, the assignment is optionally generally performed in accordance with standard procedures known in the art, except that the encoder deviates from the standard procedures by assigning an extra amount of bits to blocks including a high level of detail considered important. These extra bits assigned to the important blocks are optionally subtracted evenly from the rest of the blocks. Alternatively, the extra blocks are subtracted only from the blocks of a high level of detail that are not considered important. The amount of extra bits assigned to the important blocks may be predetermined or may be selected as that required to bring the resultant encoded QP of the block below a predetermined threshold. The predetermined threshold is optionally equal to or lower than the threshold used in determining to apply blurring to blocks, such that the important blocks are not blurred. Alternatively, in some cases important blocks may have a QP which involves blurring, but the extent of blurring applied is kept low.

In an exemplary embodiment of the invention, important blocks are assigned a sufficient number of bits such that their QP is 2-3 points below the average QP of the frame, low detail blocks are assigned bits to achieve the average QP of the frame and high texture blocks are assigned a QP which is 2-3 points above the average QP of the frame. For example, in a frame with an average QP of 32, important blocks would be assigned a QP of 29, and blocks with high texture would be blurred and assigned a QP of 35.

As to applying (312) the blurring, in some embodiments of the invention, the extent of blurring is selected in a manner which lowers the QP to a desired range. The desired QP range of the blurred blocks is optionally higher than the QP level of important blocks and/or higher that the QP level of blocks not having a high level of detail. In accordance with the above example embodiment, the extent of blurring is selected so that the QP of the block is 2-3 points above the average QP of the frame.

In some embodiments of the invention, the applying (312) of filters and encoding (314) are performed for a plurality of different blurring filters. The resulting encoded versions are decoded, the expected post processing of the decoders is applied thereto and the resulting versions are compared to the original frame to determine which blurring filter is to be used. This may be performed using any of the methods described above. It is noted, however, that this is not a necessary stage of the method of FIG. 3, and in some embodiments the encoder operates without testing different post-processing options.

### Decoder

FIG. 4 is a flowchart of acts performed by a decoder, in accordance with an exemplary embodiment of the invention. The decoder optionally receives (402) an encoded frame and decodes (404) the frame. Blocks that had a high quantization parameter (QP) are sharpened (406) in a post-processing stage.

In some embodiments of the invention, the sharpening (406) includes detail enhancement (e.g., edge enhancement) using any method known in the art. Alternatively or additionally, the sharpening (406) includes adding temporal random noise. In accordance with this alternative, the decoder selects for each block to be sharpened, a number of pixels to which noise is to be added and then randomly selects pixels of that number. Noise is added to the luminance value of each of the randomly selected pixels. Optionally, the number of pixels to which noise is added is between 10-30% of the pixels in the block. In some embodiments of the invention, the number of selected pixels is fixed for all blocks. Alternatively, the number of selected pixels is adjusted randomly.

The noise added to the selected pixels is optionally of a small extent, for example less than 10% or even less than 5% of the possible luminance values. Alternatively, the noise added is of a substantial magnitude, for example more than 20% or even more than 25% of the possible luminance values (e.g., more than 40 or even more than 60 on a scale of 0-255). In some embodiments of the invention, the noise added has a predetermined magnitude, which is the same for all pixels to which noise is added. The sign of the added noise is optionally selected randomly. Alternatively, the sign of the added noise is selected according to the luminance of the specific pixel to which the noise is added and/or the average luminance of the block. Optionally, in accordance with this alternative, the noise added to dark pixels and/or blocks is intended to brighten the pixel and the noise added to bright pixels is intended to darken the pixel. Alternatively to the noise having a predetermined magnitude, the noise added to each pixel may be selected randomly from a predetermined range, for example [−10,10] or ±[5,10].

Alternatively or additionally to adding noise to the luminance component of the pixel, noise may be added to other components of the pixel.

As to selecting the blocks to be sharpened, in some embodiments of the invention, the sharpened blocks are blocks that have a QP higher than the average QP of their frame and/or of an average QP of recent frames of the same type. Alternatively or additionally, the sharpened blocks are blocks that have a QP higher than an absolute threshold value.

Alternatively or additionally to selecting blocks to be sharpened based on QP, the blocks to be sharpened may be selected based on bit rate and/or the absolute sum of motion vectors of the frame. A large amount of motion vectors is generally indicative of more blurring applied and therefore more detail enhancement is applied to the blocks of the frame. Optionally, temporal noise addition is not used for sharpening of blocks identified based on the extent of motion vectors.

In some embodiments of the invention, the decoder performs additional post-processing beyond sharpening, such as color bias correction and/or contrast correction. Alternatively or additionally, the decoder performs deranging and deblocking.

Optionally, the post-processing depends on the size and/or type of the screen on which the decoded video from the decoder is displayed. In some embodiments of the invention, for smaller screens, more edge enhancement is performed than for large screens. Optionally, the extent of edge enhancement is larger for LCD screens than for plasma screens. Alternatively or additionally, for screens of low contrast, more contrast correction is performed.

Alternatively to selecting the blocks to be sharpened (406) based on their QP, the encoder may append to the encoded video, indications of the blocks that were blurred and the decoder applies sharpening to the indicated blocks. Further alternatively or additionally, the decoder performs image analysis and identifies blocks that were blurred and/or texture blocks that were probably blurred.

In some embodiments of the invention, the post-processing performed by the decoder depends on the type of encoder that encoded the video. Optionally, the encoder indicates its type in the encoded video, for example in each I-frame and/or at the beginning of the video. Alternatively, the decoder identifies the type of the encoder that generated the video according to the deviation of the QP values in the I-frames. If the QP deviation is indicative of an encoder that performs the method of FIG. 3, the post-processing of the method of FIG. 4 is used, and otherwise, other post-processing methods known in the art are used. Thus, in some embodiments of the invention, the decoder and encoder are completely compatible to standard encoders and decoders which do not implement embodiments of the present invention. Also, the signaling from the encoder to the decoder may be entirely within the standard encoded video (e.g., the QP values), without additional non-standard indications.

### Alternatives

Instead of sending instructions which must be used by the clients, filter selection units 120 may provide hints to allow the client simpler calculation of the post processing filters to be used and/or filter selection units 120 provide minimal or maximal boundaries of the parameters of the post-processing filters.

In some embodiments of the invention, filter selection unit 120 provides the filter instructions along with priorities assigned to the selected filters. The decoder at the client optionally selects the filters it applies according to the priorities and its available processing resources. Alternatively or additionally to priorities, the selected filters may be accompanied by indications of processing power they require and/or a measure of quality improvement they provide.

### CONCLUSION

The blocks described above may be implemented in hardware and/or software, using general purpose processors, DSPs, ASICs, FPGAs and/or other types of processing units. It will be appreciated that the above described methods may be varied in many ways, such as changing the order of steps, and/or performing a plurality of steps concurrently. It will also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. Many specific implementation details may be used.

It should be understood that features and/or steps described with respect to one embodiment may sometimes be used with other embodiments and that not all embodiments of the invention have all of the features and/or steps shown in a particular figure or described with respect to one of the specific embodiments.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Variations of embodiments described will occur to persons of the art. Therefore, the scope of the invention is limited only by the elements and limitations as used in the claims, wherein the terms “comprise,” “include,” “have” and their conjugates, shall mean, when used in the claims, “including but not necessarily limited to.”

1. A method of providing post-processing information to client decoders, comprising:
encoding a video, by an encoder;
determining one or more parameters of sharpening, color space bias correction or contrast correction for post-processing of a frame of the encoded video; and
transmitting the encoded video with the determined one or more parameters to a decoder.

2. The method of claim 1, wherein the encoding of the video and determining the one or more parameters are performed by a single processor.

3. The method of claim 1, wherein the encoding of the video and determining the one or more parameters are performed by different units.

4. The method of claim 1, comprising transmitting the encoded video from the encoder to a unit determining the one or more parameters over an addressable network.

5. The method of claim 4, wherein transmitting the encoded video to the unit determining the one or more parameters comprises transmitting along with a version of the frame including more information than available from the encoded video.

6. The method of claim 1, wherein determining the one or more parameters comprises:
decoding the frame;
applying a plurality of post-processing filters to the decoded frame; and
selecting one or more of the applied filters, based on a comparison of the results of applying the filters to the decoded frame to a version of the frame including more information than available from the encoded frame.

7. The method of claim 6, wherein selecting the one or more filters is performed at least a day after the generation of the encoded video.

8. The method of claim 6, comprising selecting additional filters for the frame after transmitting the encoded video with the parameters from the first selection to client decoders.

9. The method of claim 1, wherein the determining of parameters is repeated for a plurality of frames of the encoded video.

10. The method of claim 9, wherein the determining of parameters is repeated for at least 95% of the frames of the encoded video.

11. The method of claim 9, wherein the determining of parameters is repeated for at most one frame in each group of pictures (GOP).

12. The method of claim 1, wherein determining the one or more parameters comprises determining one or more parameters of a post-processing sharpening filter.

13. The method of claim 1, wherein determining the one or more parameters comprises determining blocks of the frame that are to be post-processed.

14. The method of claim 13, wherein determining blocks of the frame that are to be post-processed comprises determining blocks that were blurred during the encoding.

15. The method of claim 1, wherein determining the one or more parameters comprises determining one or more parameters of color bias correction filter.

16. The method of claim 1, wherein transmitting the video with the one or more parameters comprises transmitting in a manner such that the one or more parameters are ignored by decoders not designed to use the parameters.

17. The method of claim 1, wherein determining the one or more parameters comprises determining responsive to decisions made during the encoding.

18. An encoder, comprising:
an input interface which receives a video formed of frames;
an image analyzer adapted to determine for an analyzed frame, areas of the frame that are expected to be substantially degraded by encoding;
a low pass filter adapted to blur areas identified by the image analyzer; and
an encoder adapted to encode frames after areas were blurred by the low pass filter.

19. The encoder of claim 18, wherein the encoder is adapted to mark encoded frames with an indication that the encoder is adapted to perform blurring before encoding.

20. The encoder of claim 18, wherein the encoder is adapted to indicate in the encoded frame areas of the frame that were blurred.

21. The encoder of claim 18, wherein the image analyzer is adapted to determine areas that are expected to be substantially degraded by encoding, by encoding the frame.

22. The encoder of claim 18, wherein the image analyzer is adapted to determine areas that are expected to be substantially degraded by encoding, by determining a quantization parameter for blocks of the frame.

23. The encoder of claim 22, wherein the low pass filter is adapted to adjust the extent to which it blurs areas to a quantization parameter of the area.

24. The encoder of claim 18, wherein the image analyzer is adapted to determine areas that have important details and therefore will be assigned more bits for encoding and will not be degraded by encoding.

25. The encoder of claim 18, wherein the encoder is adapted to encode the frame in a manner such that areas that were blurred have a quantization parameter different from areas that were not blurred.

26. A method of encoding, comprising:
receiving a video frame by a processor;
determining by the processor areas of the frame that are expected to be substantially degraded by encoding;
blurring the determined areas; and
encoding the frame after the determined areas were blurred.

27. The method of claim 26, wherein determining the areas expected to be degraded comprises encoding the frame and determining areas requiring larger numbers of bits for their encoding.

28. The method of claim 26, wherein determining the areas expected to be degraded comprises analyzing the image to determine areas of the frame which show image details sensitive to detail loss.

29. The method of claim 26, wherein encoding the frame comprises encoding such that blurred areas have a higher quantization parameter than other areas of the frame.

30. A method of decoding a video frame, comprising:
receiving an encoded video frame, by a decoder;
decoding the received frame, by the decoder;
identifying areas of the frame that are considered to have been degraded by the encoding; and
sharpening the identified areas.

31. The method of claim 30, wherein sharpening the identified areas comprises sharpening different areas of the frame by different sharpening extents.

32. The method of claim 30, wherein identifying areas of the frame that are considered to have been degraded by the encoding comprises for some frames identifying the entire frame as requiring sharpening.

33. The method of claim 30, wherein sharpening the identified areas comprises sharpening by an extent selected responsive to an estimated degradation by the encoder.

34. The method of claim 30, wherein identifying areas of the frame comprises identifying based on the quantization parameters of the areas of the frame.

35. The method of claim 34, wherein identifying areas of the frame comprises identifying areas having a quantization parameter higher than other areas of the frame and higher than an average quantization parameter of previous frames of the same type in a video to which the frame belongs.

36. The method of claim 30, wherein identifying areas of the frame comprises identifying by image analysis.

37. The method of claim 30, wherein identifying areas of the frame comprises receiving indications of the areas in meta data supplied with the frame.

38. The method of claim 30, wherein sharpening the identified areas comprises adding temporal noise to the identified areas.

39. The method of claim 38, wherein adding the temporal noise comprises adding to pixels selected randomly.

40. The method of claim 30, wherein sharpening the identified areas comprises applying detail enhancement to the identified areas.

41. The method of claim 30, wherein sharpening the identified areas comprises detail enhancement or edge enhancement functions

42. A method of decoding a video frame, comprising:
receiving an encoded video frame, by a decoder;
decoding the received frame, by the decoder;
selecting areas of the frame that are to be sharpened and areas not to be sharpened; and
adding temporal noise to the areas selected to be sharpened but not to the areas not to be sharpened.

43. The method of claim 42, wherein selecting areas of the frame comprises selecting based on the quantization parameters of the areas of the frame.

44. The method of claim 43, wherein selecting areas of the frame comprises identifying areas having a quantization parameter higher than other areas of the frame and higher than an average quantization parameter of previous frames of the same type in a video to which the frame belongs.

45. The method of claim 42, wherein selecting areas of the frame comprises selecting by image analysis.

46. The method of claim 42, wherein selecting areas of the frame comprises receiving indications of the areas in meta data supplied with the frame.

47. The method of claim 42, wherein adding the temporal noise comprises adding to pixels selected randomly.

48. A method of decoding a video frame, comprising:
receiving an encoded video frame, by a decoder;
decoding the received frame;
determining one or more encoding parameters of the received frame; and
post processing the decoded frame using one or more attributes selected responsive to the determined one or more encoding parameters.

49. The method of claim 48, wherein post processing the decoded frame comprises sharpening areas having a high quantization parameter.

50. The method of claim 49, wherein post processing the decoded frame comprises sharpening areas having a quantization parameter higher than other areas of the frame and higher than an average quantization parameter of previous frames of the same type in a video to which the frame belongs.

51. The method of claim 48, wherein determining one or more encoding parameters comprises determining one or more quantization parameters of blocks of the frame.

52. The method of claim 48, wherein determining one or more encoding parameters comprises determining one or more motion vectors of the frame.

53. The method of claim 48, wherein post processing the decoded frame comprises post processing all the blocks of the frame using a same post processing method.

54. The method of claim 48, wherein post processing the decoded frame comprises post processing a portion of the frame using a first filter while some portions of the frame are not post processed using the first filter.

55. A method of decoding a video frame, comprising:
receiving an encoded video frame, by a decoder;
decoding the received frame;
determining one or more parameters of a screen on which the decoded frame is to be displayed; and
post processing the decoded frame responsive to the one or more determined parameters.

56. The method of claim 55, wherein the one or more parameters comprise the size of the screen.

57. The method of claim 55, wherein the one or more parameters comprise the type of the screen.

58. The method of claim 55, wherein the one or more parameters comprise the contrast ratio of the screen.

59. The method of claim 55, wherein the one or more parameters comprise the display's CPU power available for post processing functions.
